(19) United States
(12) Patent Application Publication
(10) Pub. No.: US 2008/0317657 A1
(43) Pub. Date: Dec. 25, 2008

(54) Systems and methods for capturing, isolating and sequestering carbon from CO2 in the atmosphere in the form of char produced from biomass feedstock

(76) Inventors: Harry Vem Hall, Boise, ID (US); Sheldon L. Schultz, Boise, ID (US)

Correspondence Address: Harry V. Hall, 1919 Harrison Blvd, Boise, ID, 83702, US

(21) Appl. No.: 12/214,688

(22) Filed: Jun. 20, 2008

Related U.S. Application Data
(60) Provisional application No. 60/937,104, filed on Jun. 25, 2007.

(51) Int. Cl. C01B 31/20

(52) U.S. Cl. 423/437.1

(57) ABSTRACT

The invention is a system and methods whereby biomass is gasified in a reactor vessel producing carbon char for the purpose of sequestering that char in soil, thereby reducing the carbon in the atmosphere. The invention relies on a renewable source for the biomass and a dedicated land area for sequestering the carbon char. The process in the reactor vessel is monitored and controlled to produce char with characteristics beneficial to the soil in which it is sequestered and to the plants growing in that soil. The net affect is “Carbon Negative.” The process returns only part of the carbon in the process feedstock to the atmosphere, thereby reducing atmospheric carbon dioxide in proportion to the amount of carbon char sequestered in the soil. The process produces a gas by product that may be burned for heat or used as a feedstock for other processes.

### CROSS REFERENCE TO RELATED APPLICATION

This application claims benefit of the date of filing of Provisional Application No. 60/937,104, the entire disclosure of which is hereby incorporated herein by reference for all purposes.

### BACKGROUND OF THE INVENTION

Recent finding by groups such as the United. Nations Environmental Program, the Intergovernmental Panel on Climate Change, and the Environmental Protection Agency (EPA), have increased recognition of CO₂ as a greenhouse gas. The EPA now treats CO₂ as a regulated emission. These developments increase the demand for solutions through technological developments. The present invention identifies a way to reduce atmospheric CO₂ content by using the natural, annually occurring carbon cycle of plant growth. While other CO₂ sequestration technologies address only the capture and sequestration of CO₂ produced by burning fossil fuels, this invention sequesters CO₂ from the atmosphere.

The invention comprises a system that produces carbon char through controlled gasification technology. It produces and uses solid carbon chars with physical qualities that are controlled to enrich a soil or soils of specific characteristics and needs. When mixed into the soil, the carbon char will remain in that soil(s) for years.

This invention relates to controlling that gasification process to assure production of char with characteristics that will optimize subsequent long-term sequestration of that char in soil.

Gasification of biomass in an enclosed reactor vessel, for the purpose of producing a combustible gas and char, may be achieved through use of several existing technologies. The gas has value as a source of heat, as a chemical feedstock, or for generating electricity. Char representing up to 40% of the CO2 removed from the atmosphere by the biomass growth is produced for sequestration resulting in soil enhancement and increased plant production in the future.

The production and use of char thousands of years ago by indigenous peoples in South America and Africa for the purpose of soil amendment to improve the growth and quality of crops is well documented and researched under the name “Terra Preta do Indio”.

The presence of char in soil increases plant growth rates. In the case of long-term crops or managed lands such as forests, this increased plant growth increases the amount of standing biomass on those lands. Increased plant growth rates also increase the rate that plants remove CO₂ from the atmosphere.

When in soil, char/partially activated carbon, will adsorb chemicals, specifically plant nutrients, and retain them in the soil while making them available to plants growing in the soil. Absorption of moisture by the char in the soil retains and makes available to plants, water that might otherwise run off or evaporate.

Char or carbon may be activated in an endothermic gasification process through the presence of water, steam or CO₂ as part of the reaction. At the appropriate temperatures, 595 deg C., water in the char particles or steam surrounding the particles will combine with carbon in a water shift reaction:

C+H₂O+Heat→CO+H₂.

This reaction removes carbon molecules from the char, increasing its porosity and surface area while leaving exposed carbon molecules in a state where adsorption readily takes place. Similarly, carbon and CO₂ in the presence of heat undergo a reaction:

C+CO₂+Heat→2CO

This reaction has the same result for the char particle as the water shift reaction, that is, this reaction removes carbon molecules from the char, increasing its porosity and surface area while leaving exposed carbon molecules in a state where adsorption readily takes place.

### BRIEF SUMMARY OF THE INVENTION

The present invention, known as “Carbon Negative Now™ or CN₂™, a process, wherein a harvested or waste stream biomass feedstock is processed in a reactor vessel, under controlled conditions, to produce char of varying characteristics. Increasing steam injection in the vessel, for example, can increase the chars degree of activation, which affects the chars utility as a soil amendment. The process can be controlled for many purposes, including:
Producing increased quantities of carbon char allowing long-term sequestration of the char in soil to reduce the amount of CO₂ in the atmosphere;
Varying levels of activation whereby the char characteristics provide for retention of plant nutrients by the char, thus making nutrients more readily available in treated soil which reduces the need for chemical fertilizers;
Increased carbon capture and biological sequestration from the atmosphere through enhanced growth rates and plant size.
Decreased CO₂ return to the atmosphere through reduction of plant waste decay.

The defining elements of the process are the availability of a renewable biomass source and land wherein the char/carbon will be sequestered. The available biomass is processed to provide a feedstock. The feedstock is fed mechanically, pneumatically, or manually to an enclosed steel. refractory-lined vessel where the gasification process takes place. The land producing the biomass may also be the targeted land for final disposition of the char.

The gasification vessel may be any of several types of gasifier modified to optimize the production of char rather than the production of low Btu gas. Air may be used in addition to steam, water and CO₂ to gasify biomass. The process will use air along with other oxidants to gasify biomass. The process will allow for the extraction of the char and ash produced as well as the exit of the gaseous products.

The gasification system will consist harvesting the biomass; biomass transport, processing, storage, retrieval and handling; metered feeding of the biomass to the reactor vessel; instrumentation and controls for the process variables; extraction of the char; disposal of the ash; transport of the gas for heat or process use; cooling, handling and sizing of the char; transport of the char to the area of sequestration; spreading and mixing the char into the soil; and monitoring of the soil's char content.

Because soil types and qualities vary and each plant source of biomass has different requirements, controlling the characteristics of the char to be placed in a soil can assure a close match of the char characteristics to the soil deficiencies and the requirements of the plants being grown. Controlling the amount of surface area, grain size and particle size of the char is a function of the degree of activation of the char, which will determine the adsorption and absorption capabilities of the char.

Nutrients adsorbed by the char are held in the soil and thereby made available to growing plants. This adsorption reduces the total amount of chemical fertilizer needed for healthy plant growth and also results in reduced amounts of fertilizer being lost in runoff.

The char placed and retained in the soil is removed from the global carbon cycle.

The enhanced growth rates along with an increase in the amount of growing biomass result in a larger portion of the carbon in the global carbon cycle being captured in solid form.

### BRIEF DESCRIPTION OF THE DRAWINGS

FIG. 1 (page 14) is a flow diagram representing a system for producing an annually renewable source of char and energy and illustrating a reactor vessel wherein the biomass is subjected to gasification in a sub-stochiometric environment. The figure includes systems for feeding the biomass, introducing air for the gasification process recovering heat, removing char and the by-products of the gasification The figure also depicts the instrumentation necessary to monitor the fuel feed rate, fuel moisture content, reactor vessel temperatures, char production, and the exiting gas temperature and the gas' chemical constituents of CO, CO₂, H₂, CH₄, as well as other hydrocarbons. The instrumentation is required to provide the feedback necessary to control the qualities of the char.

### DETAILED DESCRIPTION OF THE INVENTION

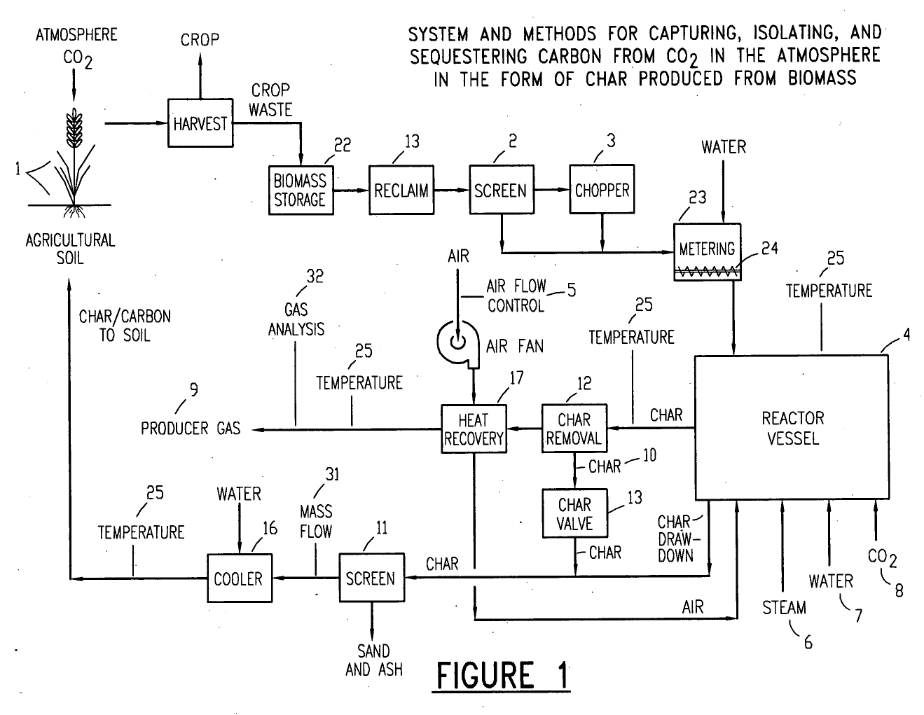

The embodiments of the disclosure will be best understood by reference to the drawing, FIG. 1 wherein like parts are designated by like numerals throughout. It will be readily understood that the components of the present invention, as generally described and illustrated in FIG. 1 herein, could be arranged and designed in a wide variety of different configurations. Thus, the following more detailed description of the embodiments of the apparatus, system, and method of the disclosure, as represented in FIG. 1, is not intended to limit the scope of the disclosure, as claimed, but is merely representative of possible embodiments of the disclosure.

This process will be the first commercially viable “Carbon Negative” process. That is, its utilization will produce usable energy while resulting in a net reduction of the amount of carbon, in the form of CO₂, in the atmosphere.

The primary physical product of the invention is granulated carbon char with a controlled level of “activation” of the carbon.

A by-product of the invention is low Btu “Producer Gas”, which may be used as a feedstock for chemical processes or for any process that requires a controlled source of thermal energy.

Referring to FIG. 1., in all embodiments the process begins with a recurring source of biomass 1 and in an ideal embodiment, as shown in FIG. 1., the process end result will return the char product to the soil where the recurring source of biomass is grown. This closed cycle of returning the char and ash minerals to the biomass source is not necessary in order to realize the full carbon sequestration and renewable energy benefits of the process. It does, however, make for a simpler overall process and may result in a more economic process.

Any of hundreds of possible sources of biomass can be appropriate as feedstock, as long as the “as used” moisture content is 60% or less by weight and there is a substantial amount of carbon in the biomass. Agricultural waste, wood waste, corn stover, and municipal solid wastes are representative examples of recurring sources of biomass.

The biomass will be transported to the location of the char production process, where it is processed by sizing in a screen 2 and larger biomass particles are reduced to a uniform size by chopping 3. The sizing of the biomass particles is the first control process that affects the quality of the product char.

The properly sized biomass is fed into the reactor vessel 4 in exact metered amounts to assure the proper ratio of reactants in the vessel.

In one embodiment, the process begins inside a refractory lined and/or water walled steel reactor vessel (one of several technological embodiments that is capable of producing char and combustible gas for this process). Within the vessel the temperature can range from 235° C. to 650° C. during the process and the gasification is controlled to assure that less than the stochiometric amount of oxygen is present in the vessel at all times.

In a later discussion of FIG. 1, see [0039], the controls for air supply 5, steam 6, water 7 or, CO₂ 8 injection, ash and char removal 10, and producer gas off-take 9 are described.

The char produced in the process can be removed from the system in two ways. First it can be captured from the reaction vessel drawdown system 10 which removes char from the reactor vessel in a continuous process. In embodiments using technologies other than fluidized bed, the char can be captured using other mechanisms such as mechanical drag chains or pneumatic means. Another embodiment of the process uses a char hopper to gather overflow of charred biomass from the primary reaction vessel as a means of removal.

A screening system 11 can also be implemented to separate the char from the ash or reactor vessel bed media. In most embodiments both ash and char will be entrained in the gas stream exiting the reactor vessel. The entrained char can be harvested from the gas stream by routing the gas stream through high efficiency cyclone or other types of particulate collectors 12 and collected from hoppers located under the cyclones through a valve 13.

Environmental controls to minimize both the production and release of CO, NOx, fly ash and other criteria pollutants for the process can be added as required.

The low heating value producer gas 9 formed as a by-product of the process, can range from 100 to 300 btu/cubic foot and contains CO₂, CO, H₂, H₂O, N₂, CH₄ and other organic and non-organic gaseous compounds. This producer gas is suitable for combustion to produce heat and steam useful in industrial processes or electricity generation. The gas may also be used as feedstock for further processing into chemicals for other industrial uses.

In order to prevent the char from combusting after removal from the reactor vessel, it must be cooled below its ignition temperature of approximately 235 deg C. In one embodiment this is accomplished by spraying the char with quench water 16.

One embodiment of the current invention contains an air pre-heater 17. The heat exchanger can take the form of a closed heat exchanger using metal tubes for the heat exchange surface. As the heated gas flows through a heat exchanger, a portion of its thermal energy is transferred to air flowing between the tubes. This heating of the air before it is transferred into the reactor vessel as gasification air improves the thermal efficiency and control of the reaction parameters within the reactor vessel.

The reactions taking place in the reactor vessel are typified by the representative wood pyrolosis reaction of:

CₐH_{b}N_{c}O_{d}+O₂→CO+CO₂+H₂+NOₓ+CH₄+C+ Heat

Where a,b,c,d and x vary as the feedstock and process is varied.

In the embodiment shown in FIG. 1., the char that is produced has the correct porosity, surface area, pore size, and particle size to optimize nutrient and moisture retention and availability for the combination of soil type and plant type to be grown in the soil to which it is returned for sequestration; that is, the soil where the feedstock biomass originated.

Long term sequestration, hundreds to thousands of years, occurs when the char is used as a soil amendment.

In FIG. 1 an embodiment of the reactor vessel 4 depicts the use of devices for measurement and control of the conditions in the reactor vessel that determine the characteristics of the char. The control parameters are: feedstock particle size and feedstock moisture content, feedstock rate of input to the vessel, vessel temperature, particle residence time, the ratio of air mass input to the mass of feedstock input, inlet air temperature, and input of additional water, steam or CO₂.

Feedstock particle size affects the activation of the char and the handle-ability of the product. Particle size is controlled by screening, 2 and chopping 3 of the char when received and when reclaimed 13 from storage 22 for feeding to the reactor vessel.

Feedstock moisture content affects the level of activation of the char. Moisture content is controlled by allowing the material to dry while in storage or by adding moisture to either the reactor vessel during the process or to the fuel as it is metered 23 into the reactor vessel.

Feedstock input rate changes the product by changing the stochiometric ratio of the gasification reaction, thereby affecting the rate of gasification, the temperature and the level of char activation. Biomass feed rate is controlled by a variable speed feeding mechanism that, in this embodiment, is typified by variable speed feedscrews 24.

The temperature in the vessel affects the rate of gasification and the level of char activation. Temperature is closely monitored 25 and will be controlled by varying the biomass feed rate the inlet air flow,, the char removal rate (mass flow) 31, the stochiometric ratio of the reaction, the residence time of the biomass/char particles, and the feed of water, steam and or CO₂.

FIG. 1, also depicts the instrumentation necessary to the exiting gas temperature 25 and producer gas constituents of CO, CO₂, H₂, CH₄, and O₂, 32 for the purpose of feedback necessary to control the process.

1. A system for capturing and sequestering atmospheric carbon, in the form of char derived from biomass.

2. The system of claim 1 wherein the biomass is obtained from a growing renewable source.

3. The method of claim 1 using sub-stochiometric gasification of the biomass in a reactor vessel.

4. The method of claim 3 further comprising using the reactor vessel to gasify the biomass feedstock at a temperature between 235° C. and 650° C.

5. The method of claim 3 wherein the reactor vessel is equipped with instrumentation and controls which provide for control physical and chemical characteristics of the char.

6. The methods of claims 3, 4 and 5 further comprising process controls to achieve specific biomass feedstock processing and combustion reaction parameters such that the char produced is uniquely suited for long-term sequestration in soil and for specific soils and crops to increase growth rates and mass of crop yields.

7. The method of claim 3 further comprising a mechanical or pneumatic char and ash removal system.

8. The method of claim 3 further comprising environmental controls to minimize the release of pollutants.

9. The method of claim 3 further comprising a mechanism for sampling material produced in and removed from the vessel.

10. The method of claim 3 further comprising using a pipe to remove the gas produced by the gasification of claim 1.

11. The system of claim 4 wherein the characteristics of the char allow for long-term sequestration of the char as a soil amendment.

12. The method of claim 10 further comprising metal housing and tubing disposed as closed heat exchangers that heat the combustion air and cool the exiting gases.

13. The method of claim 10 comprising one or more cyclone particulate collectors connected to the vessel such that the collectors receive the vessel's exiting exhaust stream.

14. The method of claim 13 further comprising metal ductwork through which the producer gas off-take for the cooled and cleaned gas exits the cyclonic particulate collector and is transported for subsequent use.

15. The methods of claims 1 through 14 comprise a system for removal and long term sequestration of atmospheric carbon that includes the production of usable thermal energy in the form of producer gas, the net operating affect of which is a “Carbon Negative” process, that is, a process that removes more carbon from the atmosphere than it returns to the atmosphere.
